(19) United States
(12) Patent Application Publication
(10) Pub. No.: US 2005/0213427 A1
(43) Pub. Date: Sep. 29, 2005

(54) Mixing utility, liquid viscometric apparatus

(76) Inventors: Warren P. Steckle JR., Los Alamos, NM (US); Mark E. Smith, Los Alamos, NM (US); Jeffrey R. Griego, Dixon, NM (US); Frank Fierro, Rio Rancho, NM (US)

Correspondence Address: UNIVERSITY OF CALIFORNIA;LOS ALAMOS NATIONAL LABORATORY, P.O. BOX 1663, MS A187, LOS ALAMOS, NM, 87545, US

(21) Appl. No.: 10/808,173

(22) Filed: Mar. 23, 2004

(51) Int. Cl. B01F 5/12

(52) U.S. Cl. 366/268

(57) ABSTRACT

An apparatus for foam emulsion processing, and/or determination of the rheological parameters of a given sample includes a syringe assembly, a movable assembly, and a platform assembly. The syringe assembly has a first and second syringe connected by a capillary tube (emulsion needle). The movable assembly includes a holder tube within which the syringe assembly is secured. The platform assembly restrains movement of the movable assembly to only one axis.

### STATEMENT REGARDING FEDERAL RIGHTS

This invention was made with government support under Contract No. W-7405-ENG-36 awarded by the U.S. Department of Energy. The government has certain rights in the invention.

### FIELD OF THE INVENTION

The present invention relates generally to monitoring rheological parameters of liquid and plastic-solid samples during shear processing, and, more particularly, to process mixing of foam emulsions.

### BACKGROUND OF THE INVENTION

Rheology is the study of the deformation and flow of matter, especially non-Newtonian flow of liquids and plastic flow of solids. Rheometers are instruments for determining flow properties of liquids and plastic flow of solids by measuring relationships between stress, strain, and time. Rheometers are used in various fields of application, including, but not limited to: food rheology, paints, concrete, cosmetics, biomedical materials, waste analysis, petroleum processing, plastics, rubbers, and adhesives.

The present invention comprises a type of rheometer that allows for the application of uniform shear in the generation of foam emulsions. Commercial systems are currently not available over the range of operating loads (0-40 lbf) typically encountered in the generation of foam emulsions. The present invention allows for the monitoring of the applied force in compression and/or tension in real time over an operating range of 0-1000 lbf. The resulting data can then be directly translated to determine the evolution of the sample viscosity as a function of the process variables and formulation.

U.S. Pat. No. 6,575,019, “Reciprocating Drive/Pump System and Reciprocating Capillary Viscometer Utilizing Same”, issued Jun. 10, 2003, by David B. Larson, teaches a viscometer (rheometer) using a bi-directional dual piston syringe pump assembly. Thus, there is one chamber and one piston. As the piston moves from one end of the chamber to the other, the processing fluid is displaced out of the chamber, through a long capillary tube, and back into the chamber on the other side of the piston. Instruments connected to the capillary tube detect rheological parameters.

There are differences between the viscometer taught in Larson, supra, and the present invention. Larson's viscometer relies on a pressure transducer arrangement to measure the pressure drop across the capillary. The present invention uses a load cell force measurement taken during the exchange of the sample volume between two syringe chambers connected by a capillary (syringe assembly) to determine viscosity.

Maintaining a stable sample temperature is important when determining rheological parameters. Larson indicates no ability to maintain temperature in the sample reservoirs, and, thus, the sample. However, the entire assembly of the present invention may be placed in an environmental chamber in order to maintain uniform temperature for all of the test material.

The capillary taught in Larson is designed for a single capillary of a certain length. The present invention allows for the use of interchangeable capillaries of differing cross-sectional sizes. Thus, different test material shear rates may be introduced and the resulting rheological measurements may be obtained.

Larson's viscometer does not denote the sample volume or the ability to adjust for different-sized samples. The present invention is designed to accommodate syringe sizes from 10 cc to 50 cc, and can be easily modified to even larger syringe sizes.

Lastly, the viscometer taught in Larson requires significant maintenance between operations. For example, Larson's viscometer requires a flushing operation between processing different samples in order to clean out both ends of the piston chamber and the capillary tube. The design of the present invention allows for rapid removal and replacement of the syringe assembly (sample container) without any cleaning required.

Various objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

In accordance with the purposes of the present invention, as embodied and broadly described herein, an apparatus for foam emulsion processing, and/or determination of the rheological parameters of a given sample, includes a syringe assembly, a movable assembly, and a platform assembly. The syringe assembly has a first and second syringe connected by a capillary tube (emulsion needle). The movable assembly includes a holder tube within which the syringe assembly is secured. The platform assembly restrains movement of the movable assembly to only one axis.

### BRIEF DESCRIPTION OF THE DRAWINGS

The accompanying drawings, which are incorporated in and form a part of the specification, illustrate the embodiments of the present invention and, together with the description, serve to explain the principles of the invention. In the drawings:

FIG. 1 is a 3 pictorial illustration in partial cutaway of the present invention.

FIG. 2 is a side view of the syringe assembly, movable assembly, and platform assembly of the present invention.

FIG. 3 is a side view of the syringe assembly.

FIG. 4 is a side view of the movable assembly.

FIG. 5 is side view of the platform assembly.

FIG. 6 is a cross-section of the present invention.

### DETAILED DESCRIPTION

The present invention comprises an apparatus and method that determines rheological parameters of fluid samples and generates foam emulsions for use in various applications. One embodiment of the present invention uses two syringes connected by a capillary (emulsification needle) to perform these operations. Through this compact design the sample environment is fully contained. Sample chambers may be discarded after testing; therefore no cleaning of the apparatus is required.

Mechanical Design

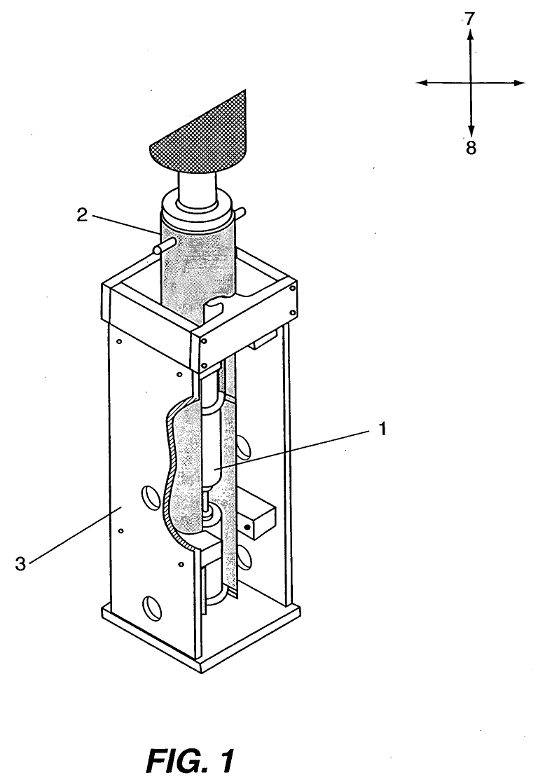

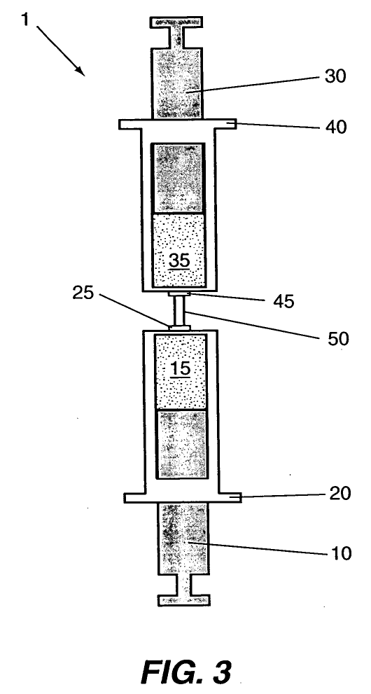

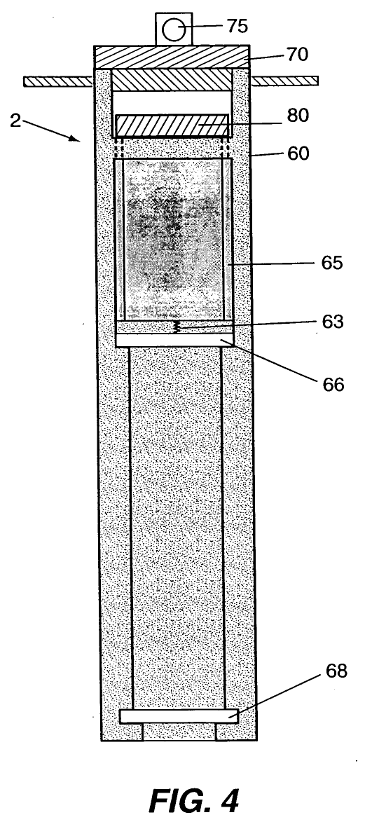

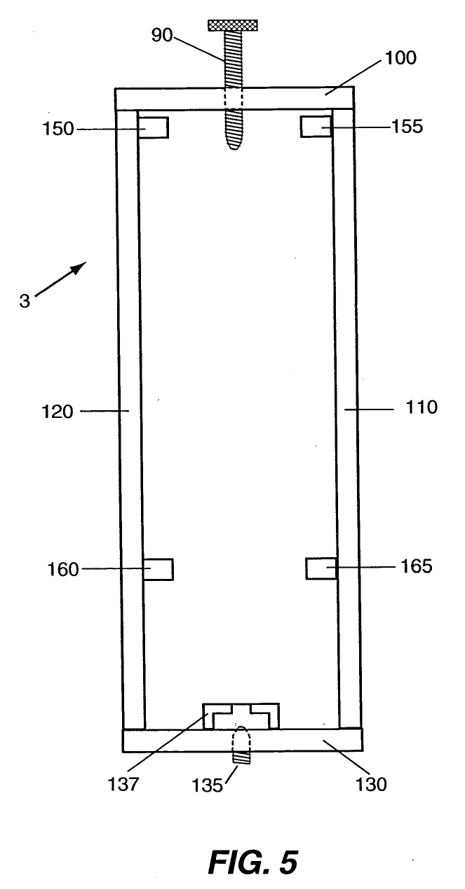

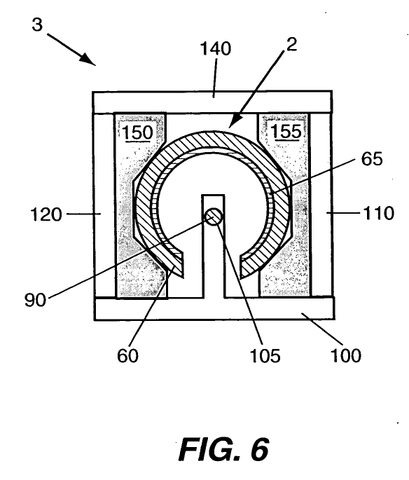

Referring to FIG. 1, one embodiment of the present invention comprises three main components: syringe assembly 1, movable assembly 2, and platform assembly 3. Syringe assembly 1 is secured within movable assembly 2. Movable assembly 2 moves in a reciprocating motion (back and forth) along directional axis 7, 8 within platform assembly 3. FIG. 3 illustrates syringe assembly 1. FIG. 4 illustrates movable assembly 2. FIG. 5 illustrates platform assembly 3. FIG. 6 is a cross sectional view illustrating how movable assembly 2 resides within platform assembly 3.

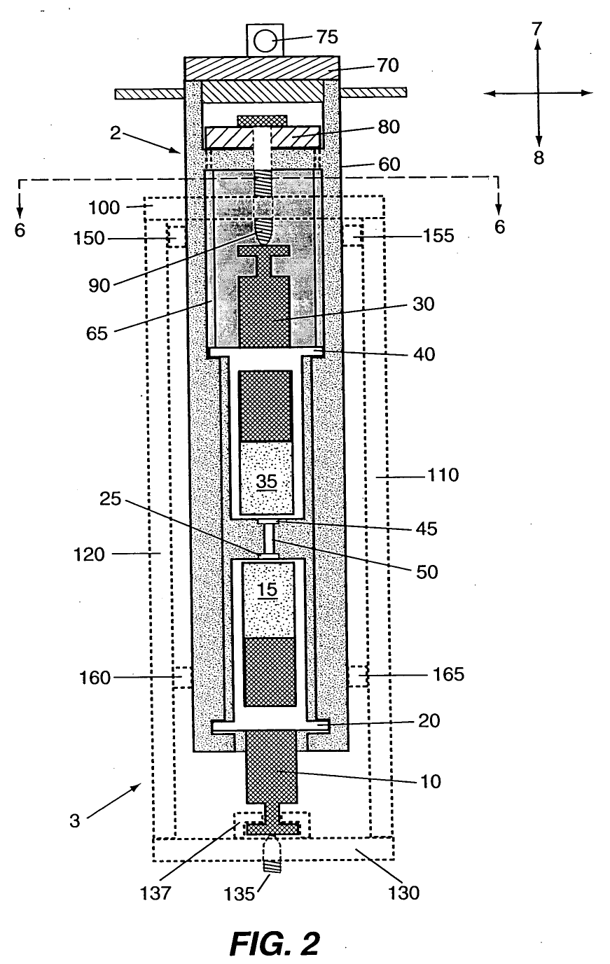

Referring to FIGS. 2, 3, 4, and 5, determining the Theological parameters of a given sample is carried out by drawing the sample to be processed into either first syringe barrel 35 or second syringe barrel 15. If foam emulsification is being performed, then a first fluid is drawn into first syringe barrel 35 and a second fluid is drawn into second syringe barrel 15. Syringe assembly 1, comprising a first and second syringe, is then assembled by connecting output port 45 of first syringe barrel 35 with output port 25 of second syringe barrel 15 through capillary tube 50 (also called an emulsion needle).

Syringe assembly 1 is then placed into movable assembly 2. Movable assembly 2 includes holder tube 60 that defines first slot 66 and second slot 68, which engage first flange 40 and second flange 20 of syringe assembly 1, respectively. Syringe assembly 1 is held within movable assembly 2 by a securing assembly comprising adjusting retainer nut 80, spacer 65, and spring 63, thereby placing a downward force on, and securing first flange 40 within first slot 66. Spacer 65 allows for the accommodation of different sized syringes.

Movable assembly 2 is held within platform assembly 3 by first pair of vee blocks 150, 155 and second pair of vee blocks 160, 165, and, which are made of plastic (e.g. Teflon®) or any material exhibiting a low friction coefficient, such that holder tube 60 is constrained to move only along one directional axis 7, 8 in a reciprocating motion. Second plunger 10 is manually manipulated into lower retainer coupling 137 and ball plunger screw 135 is tightened to secure second plunger 10 to base plate 130. Adjustment means (e.g. screw) 90, which is centered over first plunger 30, is adjusted to center first plunger 30 and to prevent upward movement of first plunger 30 during operation.

Platform assembly 3 may be secured to a mount (not shown) at base plate 130. Support members 110, 120 structurally connect base plate 130 with T-cross member 100 and upper cross member 140. Vee block 160 and Vee block 150 are attached to support member 120, and Vee block 165 and Vee block 155 are attached to support member 110. T-cross member 100 is one of the upper structural cross members of platform assembly 3 and is shaped to fit inside holder tube 60 (refer to FIG. 6). T-cross member 100 includes adjustment means 90 that is axially aligned with lower retainer coupling 137 along directional axis 7, 8. Adjustment means 90 is centered over first plunger 30, facilitating the centering of syringe assembly 1 within holder tube 60. Upper cross member 140 provides structural stability to platform assembly 3.

Large jam nut 70 mechanically holds attachment lug 75 onto the top of holder tube 60. Attachment lug 75 may be attached to a load cell (not shown) that is provided with a means for providing reciprocating motion of movable assembly 2. Any means that can provide reciprocating displacement of movable assembly 2 within platform assembly 3 sufficient to transfer the sample between first syringe barrel 35 and second syringe barrel 15 is acceptable for purposes of operating embodiments of the present invention. In one embodiment, a computer controlled load frame is used as the reciprocating displacement means.

As the type and size of the load cell used, rate control of the reciprocating means, and orifice size are readily changeable, many operating ranges are possible.

Operation

When operation of the present invention is ready to begin, the reciprocating displacement means is placed into motion. Referring to FIG. 2, during movement of movable assembly 2 in axial direction 7, second plunger 10 is secured by lower retainer coupling 137 and does not move, but second syringe barrel 15 moves with holder tube 60. The motion in axial direction 7 displaces second plunger 10 out of second syringe barrel 15. During movement in axial direction 7, first plunger 30 is prevented from moving by adjustment means 90. Thus, first syringe barrel 35 is forced over first plunger 30, causing plunger 30 to displace the sample down through capillary 50 into second syringe barrel 15.

During movement in axial direction 8, the process is reversed. Second plunger 10 pushes the sample out of second syringe barrel 15 through capillary 50 and back into first syringe barrel 35 as second syringe barrel 15 is pushed down over second plunger 10 by holder tube 60. Note that first plunger 30 is displaced out of first syringe barrel 35 by the force of the sample being pushed out of second syringe barrel 15. The process is repeated until the operation is completed.

Syringe assembly 1 is removed by loosening adjustment means 90, ball plunger screw 135, and retainer nut 80. The processed sample can then be removed and a new syringe assembly placed into holder tube 60.

Embodiments of the present invention may be placed in any spatial orientation, as the emulsification process and/or rheological parameter determination is not affected by gravity or spatial orientation. Thus, directional axis 7, 8 may be horizontal, vertical, or any angle in-between horizontal and vertical.

Rheological measurements, including kinematic and dynamic viscosity, shear rate, velocity through capillary, and wall stress of the sample, are determined by knowing the applied force (as given by an attached load cell) and calculating for a fixed volume that passes through a known orifice (capillary tube) at a controlled rate.

The applied force measurement, used in the calculation of the above rheological measurements, is obtained by subtracting the amount of force required to move movable assembly 2 when the sample is not present from that force required to move assembly 2 when the sample is present. Hence, embodiments of the present invention do not use probes (transducers) in direct contact with the sample for measurement.

If the present invention is used as a foam emulsifier, the foam emulsification process of a sample comprising two fluids is considered complete when monitoring indicates that the sample exhibits the desired Theological parameters.

The foregoing description of the invention has been presented for purposes of illustration and description and is not intended to be exhaustive or to limit the invention to the precise form disclosed, and obviously many modifications and variations are possible in light of the above teaching.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. An apparatus for determining rheological parameters of a sample or to produce a foam emulsion, comprising:
(a) a syringe assembly comprising a first syringe, a second syringe, and a capillary tube, said first and second syringe in fluid communication through said capillary tube,
(b) a movable assembly, said syringe assembly secured within said movable assembly, and
(c) a platform assembly connected to constrain said movable assembly to one axis of motion.

2. The apparatus of claim 1 where said movable assembly comprises:
(a) a spacer, and
(b) a retainer nut,
(c) where said syringe assembly is secured within said movable assembly by said spacer and said retainer nut.

3. The apparatus of claim 1 where said platform assembly comprises:
a base plate, a lower retainer coupling, a ball plunger screw, and an adjustment means, said syringe assembly secured by said lower retainer coupling and said ball plunger screw to said base plate, and restricted in movement along said one axis of motion by said adjustment means.

4. An apparatus for determining rheological parameters of a sample or to produce a foam emulsion, comprising:
(a) a first syringe having a first barrel and a first plunger,
(b) a second syringe having a second barrel and a second plunger,
(c) a tube connecting said first barrel with said second barrel,
(d) a movable assembly, said first barrel and said second barrel removably fixed within said movable assembly, and
(e) a platform assembly connected to constrain movement of said movable assembly to one axis of motion, connected to said first plunger and constraining said second plunger to restrain said first plunger and said second plunger for movement within said first barrel and said second barrel, respectively, as said first barrel and said second barrel move with said movable assembly along said one axis of motion.

5. The apparatus of claim 4 where said movable assembly further comprises a holder tube defining a first slot for removably confining said first barrel and a second slot for removably confining said second barrel.

6. The apparatus of claim 5, where said movable assembly further comprises a spacer for contacting said first barrel with said first slot and a securing assembly for urging said spacer against said first barrel.

7. The apparatus of claim 4, where said platform assembly further includes a lower retainer coupling for removably receiving said second plunger to prevent movement of said second plunger as said movable assembly moves along said one axis of motion.

8. The apparatus of claim 4 where said platform assembly further includes an adjustment means for contacting said first plunger to prevent movement of said first plunger along said one axis of motion.

9. The apparatus of claim 4 where said platform assembly further includes first and second pairs of vee blocks axially displaced within said platform assembly and contacting said movable assembly to constrain movement of said movable assembly to said one axis of motion.

10. A method for determining rheological parameters of a fluid, comprising:
(a) forming a syringe assembly having a first syringe with a first barrel and a first plunger, a second syringe with a second barrel and a second plunger, and a tube connecting said first barrel and said second barrel for transporting fluid therebetween,
(b) placing said fluid within said first barrel or said second barrel,
(c) securing said first barrel and said second barrel to a movable assembly,
(d) coupling said second plunger to a platform assembly to isolate movement of said second plunger from movement of said second barrel, and restraining said first plunger to isolate movement of said first plunger from movement of said first barrel,
(e) reciprocally moving said movable assembly along one axis of motion so that said first plunger and said second plunger move within said first barrel and said second barrel, respectively, to move said fluid between said first barrel and said second barrel through said tube.

11. The method of claim 10, further including: measuring the force required to move said movable assembly as a measure of rheological parameters of said fluid.

12. The method of claim 10, further including: placing first and second fluids within said syringe assembly, measuring the force required to move said movable assembly as said first and second fluids move within said syringe assembly, and reciprocating said movable assembly until said force indicates that a desired mixing condition between said first and second fluids has been obtained.
